(19) United States
(12) Patent Application Publication
(10) Pub. No.: US 2007/0122113 A1
(43) Pub. Date: May 31, 2007

(54) INFORMATION REPRODUCING APPARATUS AND INFORMATION REPRODUCING METHOD

(76) Inventor: Nobuyuki SUZUKI, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/539,008

(22) Filed: Oct. 5, 2006

(30) Foreign Application Priority Data
Nov. 30, 2005 (JP) 2005-347112

(51) Int. Cl. H04N 7/00

(52) U.S. Cl. 386/95

(57) ABSTRACT

According to one embodiment, an offset between time bases of first and second digital offset data series is calculated on the basis of a reproduction start time included in the first digital data series, a reproduction start time included in the second digital data series, and a playlist for specifying a reproduction sequence of the first and second digital data series in units of video fields, and the thus calculated offset is added to time information included in the second digital data series.

### CROSS-REFERENCE TO RELATED APPLICATIONS

This application is based upon and claims the benefit of priority from Japanese Patent Application No. 2005-347112, filed Nov. 30, 2005, the entire contents of which are incorporated herein by reference.

### BACKGROUND

1. Field

One embodiment of the invention relates to an information reproducing apparatus and an information reproducing method for synchronously reproducing a plurality of program streams having different time bases.

2. Description of the Related Art

As is well known, in recent years, optical disks such as digital versatile disks (DVDs) have been prevalent as digital recording media. In addition, there has been a demand for high reliability in optical disk devices for reproducing these optical disks.

DVDs have progressed in specification. Currently, a next-generation DVD standard has been completed, the standard being compatible with high-definition video and referred to as, for example, high-definition (HD) DVD or Blueray. In the next-generation DVD standard, recording density becomes remarkably higher than in the current DVD standard. For this reason, there has been a demand for an optical disk device having high functionality that corresponds to such higher recording density.

That is, the DVD Video standard permits reproduction of only one program stream. In the HD DVD standard, in contrast, it is mandatory to synchronously reproduce two systems of program streams (a primary program stream and a secondary program stream), which are multiplexed separately and which are free of a time relationship.

Specifically, a main video signal, a sub video signal, a sub picture signal, a main audio signal, and a sub audio signal are recorded on an optical disk as the primary program stream. An optical disk device can selectively reproduce these five types of primary program stream.

On the other hand, the optical disk device is capable of acquiring a sub video signal, a main audio signal, and a sub audio signal as the secondary program stream from a server via a network. There is a demand for a function of replacing the sub video signal, main audio signal, and sub audio signal obtained from the optical disk with the sub video signal, main audio signal, and sub audio signal selectively obtained from the server, and then, synchronously reproducing the replaced signals.

In Jpn. Pat. Appln. KOKAI Publication No. 11-112452, there is disclosed a configuration of synchronously reproducing two transport streams having different time bases. However, in this publication, an offset between the time bases of the two transport streams is detected and the time bases are synchronized by using a program clock reference (PCR). For this reason, it is impossible to precisely obtain video synchronization.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating an optical disk device according to an embodiment of the present invention;

FIG. 2 is a block diagram specifically illustrating a decoder unit and its periphery in the present embodiment;

FIG. 3 is a view illustrating an example of a playlist acquired from an optical disk in the present embodiment;

FIG. 4 is a view illustrating an exemplary operation of synchronizing a primary program stream and a secondary program stream in the present embodiment;

FIG. 5 is a flowchart illustrating the operation of synchronizing a primary program stream and a secondary program stream in the present embodiment; and

FIG. 6 is a view illustrating another exemplary operation of synchronizing a primary program stream and a secondary program stream in the present embodiment.

### DETAILED DESCRIPTION

Various embodiments according to the invention will be described hereinafter with reference to the accompanying drawings. In general, according to one embodiment of the invention, an offset between time bases of first and second digital offset data series is calculated on the basis of a reproduction start time included in the first digital data series, a reproduction start time included in the second digital data series, and a playlist for specifying a reproduction sequence of the first and second digital data series in units of video fields, and the thus calculated offset is added to time information included in the second digital data series.

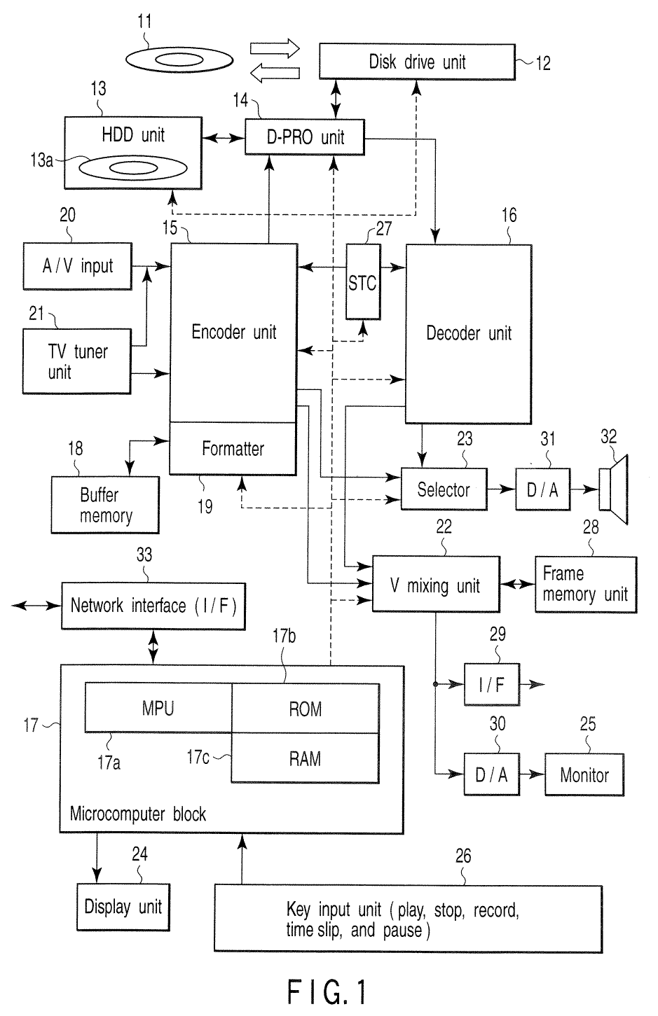

FIG. 1 shows an optical disk device described in the present embodiment. The optical disk device can handles both an HD DVD and a hard disk as recording media. The hard disk or HD DVD may be replaced with a recording medium using a semiconductor memory, for example.

Blocks in FIG. 1 are roughly divided into a main block of a recording unit at the left side and a main block of a reproducing unit at the right side.

The optical disk device shown in FIG. 1 has two types of disk drive units. First, the optical disk device has a disk drive unit 12 that rotationally drives an optical disk 11 serving as a first medium that is an information recording medium capable of constructing a video file and executes information reading and writing. In addition, the optical disk device has a hard disk drive (HDD) unit 13 that drives a hard disk 13a serving as a second medium.

A data processor unit 14 can supply recording data to the disk drive unit 12 and the HDD unit 13, and can receive signals reproduced from the disk drive unit 12 and the HDD unit 13.

The disk drive unit 12 has a rotation control system, a laser drive system, an optical system and the like compatible with the optical disk 11. The data processor unit 14 handles data defined in units of recording or reproduction, and includes a buffer circuit, a modulator/demodulator circuit, an error correcting unit and the like.

Also, the optical disk device shown in FIG. 1 primarily comprises an encoder unit 15 that configures a recording side, a decoder unit 16 that configures a reproduction side, and a microcomputer block 17 that controls an operation of a main body of the disk device.

The encoder unit 15 has: a video and audio analog/digital converter that digitizes an input analog video signal or an input analog audio signal; and an encoder that encodes main video, sub video, sub picture, main audio, and sub audio signals, etc. An output of the encoder unit 15 is converted into a predetermine DVD-RAM format at a formatter 19 that includes a buffer memory 18, and then, the converted output is supplied to the above-described data processor unit 14.

Input to the encoder unit 15 are an external analog video signal and an external analog audio signal from an audio/video (A/V) input unit 20 or an analog video signal and an analog audio signal from a television (TV) tuner unit 21.

The encoder unit 15 can supply a compressed digital video signal and a compressed digital audio signal directly to the formatter 19 when the compressed digital video signal and digital audio signal are directly input.

The encoder unit 15 can also supply digitized video and audio signals directly to a video (V) mixing unit 22 or an audio selector 23.

In a video encoder included in the encoder unit 15, a digital video signal is converted into a digital video signal compressed at a variable bit rate based on the Moving Picture Experts Group (MPEG) 2 or MPEG1 standard.

A digital audio signal is converted into a digital audio signal compressed at a fixed bit rate or into a digital audio signal of linear pulse code modulation (PCM) based on the MPEG or Audio Compression (AC)—3 standard.

In the case where a sub video or a sub picture (such as a signal from an HD DVD player with an independent output terminal for sub video or sub picture) has been input from the A/V input unit 20, or alternatively, in the case where an HD DVD signal having such a data configuration is broadcast and the signal is received at the TV tuner unit 21, the sub video or sub picture contained in the HD DVD signal is encoded (run length encoded) by means of an encoder to be produced as a bit map.

The encoded digital video signal and digital audio signal, etc., are packed at the formatter 19 to be produced as a main video pack, a sub video pack, a sub picture pack, a main audio pack, and a sub audio pack. Further, these packs are collected to be converted into a format defined in the HD DVD standard.

Here, the optical disk device shown in FIG. 1 can supply the information formatted at the formatter 19 (packs of main video, sub video, sub picture, main audio, and sub audio, etc.) and produced management information to the HDD unit 13 or the disk drive unit 12 via the data processor unit 14, and record the supplied information to the hard disk 13a or the optical disk 11.

The information recorded in the hard disk 13a or the optical disk 11 can be also recorded in the optical disk 11 or the hard disk 13a via the data processor unit 14 or the disk drive unit 12.

In addition, edit processing may be applied such as partially deleting video objects of plural programs recorded in the hard disk 13a or the optical disk 11 or connecting objects of different programs. This is because data units handled by the format according to the present embodiment are defined to make editing easy.

The microcomputer block 17 includes a microprocessing unit (MPU) [or central processing unit (CPU)] 17a, a read only memory (ROM) 17b having a control program and the like written therein, and a RAM 17c for providing a work area required to execute a program.

The MPU 17a of the microcomputer block 17 uses the RAM 17c as a work area in accordance with the control program stored in the ROM 17b, and executes fault site detection, unrecorded region detection, recording information/recording position setting, universal disk format (UDF) recording, AV address setting, and the like.

In addition, the microcomputer block 17 has an information processing unit required to control a whole system. The microcomputer block 17 comprises a work RAM, a directory detecting unit, a VMG (whole video management information) information producing unit, a copy related information sensing unit, a copy and scrambling information processing unit (RDI processing unit), a packet header processing unit, a sequence header processing unit, an aspect ratio information processing unit, an encode processing unit, a decode processing unit, and the like.

From among the execution results of the microcomputer block 17, the contents to be notified to a user are displayed on a display unit 24 incorporated in the optical disk device or are displayed by on-screen display (OSD) on an externally connected monitor display 25. The microcomputer block 17 also has a key input unit 26 that supplies an operating signal for operating the optical disk device.

A determination of a timing for the microcomputer block 17 to control the disk drive unit 12, the HDD unit 13, the data processor unit 14, the encoder unit 15, and/or the decoder unit 16 can be executed on the basis of time data from a system timing clock (STC) 27.

Although operations of recording and reproducing are executed in synchronization with a time clock from the STC 27, the other processings may be executed at a timing independently of the STC 27.

Although described later in detail, the decoder unit 16 has: a separator that separates and takes out packs from signals that conform to the HD DVD standard, having a pack structure; a memory to be used at the time of pack separation or executing another signal processing; a decoder that decodes the main video, sub video, sub picture, main audio, and sub audio signals separated by the separator; and the like.

The decoder unit 16 also comprises a video processor for properly synthesizing the decoded sub video or sub picture with the decoded main video, thereby outputting a menu, a highlighted button, a subtitle or any other image to be superimposed on the main video.

A video signal output from the decoder unit 16 is input to the V mixing unit 22. The V mixing unit 22 synthesizes text data. A line for directly acquiring signals from the TV tuner unit 21 and the A/V input unit 20 is also connected to the V mixing unit 22.

A frame memory unit 28 to be used as a buffer is connected to the V mixing unit 22. In the case where an output of the V mixing unit 22 is an analog output, the analog output is externally forwarded via an interface (I/F) 29. In the case of a digital output, the digital output is forwarded to the monitor display 25 via a digital-to-analog converter 30.

An audio signal output from the decoder unit 16 is converted to analog by a digital-to-analog converter 31 via the selector 23, and the analog-converted signal is output to an externally connected speaker 32. The selector 23 is controlled by a select signal from the microcomputer block 17.

In this manner, when a digital signal from the TV tuner unit 21 or the A/V input unit 20 is directly monitored, the selector 23 can directly select a signal having passed through the encoder unit 15.

The formatter 19 of the encoder unit 15 creates each item of isolation information during recording, and periodically sends them to the MPU 17a of the microcomputer block 17 [information such as head interruption of GOP (group of picture)]. The isolation information includes the number of video object unit (VOBU) packs, an end address of intra (I) picture from the head of VOBU, a VOBU reproduction time, and the like.

At the same time, information acquired from the aspect ratio information processing unit is sent to the microcomputer block 17 at the time of starting recording, and the MPU 17a creates VOB stream information (STI). Here, STI stores resolution data, aspect data and the like, and initial setting is provided on the basis of the information at each decoder unit at the time of reproduction.

In addition, in this recording and reproducing apparatus, a video file is defined as one file in one disk. While a data access (seek) is provided, minimally continuous information units (sizes) are determined in order to continue reproduction without interruption. This unit is referred to as contiguous data area (CDA). A CDA size is provided as a multiple of error correction code (ECC) block (16 sectors). In a file system, recording is carried out in units of the CDA.

The data processor unit 14 receives data in units of VOBU from the formatter 19 of the encoder unit 15 to supply data defined in units of CDA to the disk drive unit 12 or the HDD unit 13.

The MPU 17a of the microcomputer block 17 creates management information required to reproduce recorded data. When the MPU recognizes a command of the end of data recording, it sends the created management information to the data processor unit 14.

In this manner, the management information is recorded in the optical disk 11. Therefore, during encoding is carried out, the MPU 17a of the microcomputer block 17 receives from the encoder unit 15 information (such as isolation information) defined in units of data.

The MPU 17a of the microcomputer block 17 recognizes management information (file system) read from the optical disk 11 and the hard disk 13a at the time of starting recording, recognizes an unrecorded area of each disk, and sets a record area on data to a disk via the data processor unit 14.

Furthermore, the MPU 17a of the microcomputer block 17 is connected to an external server via a network interface 33. In this manner, the optical disk device can selectively replace information such as sub video, main audio, and sub audio acquired from the server with sub video, main audio, and sub audio reproduced from the optical disk 11, thereby reproducing the replaced information.

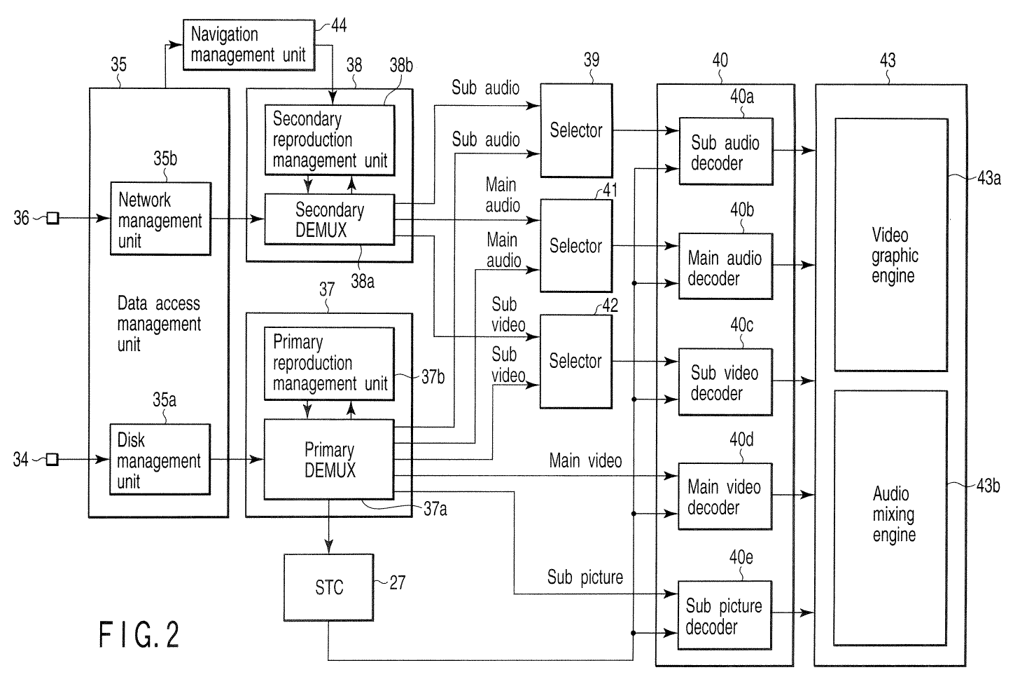

FIG. 2 shows a specific configuration of the above-described decoder unit 16 and its periphery. In FIG. 2, reference numeral 34 denotes an input terminal to which reproduction information from the optical disk 11 is supplied. The reproduction information supplied to the input terminal 34 is supplied to a disk management unit 35a that configures a data access management unit 35, so that a primary program stream that is a first digital data series is extracted.

In FIG. 2, reference numeral 36 denotes an input terminal to which acquisition information from a server (not shown) is supplied. The acquisition information supplied to the input terminal 36 is supplied to a network management unit 35b that configures the data access management unit 35, so that a secondary program steam that is a second digital data series is extracted.

Here, assume that the above-described primary program stream and secondary program stream are multiplexed separately, respectively, and are different in time base. The secondary program stream is provided as a stream for replacing a sub video, a main audio, and a sub audio of the primary program stream.

Then, the primary program stream output from the above-described disk management unit 35a is supplied to a primary demultiplexer 37a that configures a demultiplexer unit 37. The primary demultiplexer 37a demultiplexes main video, sub video, sub picture, main audio, and sub audio signals from the input primary program stream under the control of a primary reproduction management unit 37b.

On the other hand, the secondary program stream output from the above-described network management unit 35b is supplied to a secondary demultiplexer 38a that configures a demultiplexer unit 38. The secondary demultiplexer 38a demultiplexes sub video, main audio, and sub audio signals from the input secondary program stream under the control of a secondary reproduction management unit 38b.

The sub audio signal demultiplexed by the primary demultiplexer 37a and the sub audio signal demultiplexed by the secondary demultiplexer 38a are selectively supplied by a selector 39 to a sub audio decoder 40a that configures a decoder unit 40 to be subjected to decode processing. By switching the selector 39 at a predetermined timing, it becomes possible to replace the sub audio of the primary program stream with the sub audio of the secondary program stream.

In addition, the main audio signal demultiplexed by the primary demultiplexer 37a and the main audio signal demultiplexed by the secondary demultiplexer 38a are selectively supplied by a selector 41 to a main audio decoder 40b that configures the decoder unit 40 to be subjected to decode processing. By switching the selector 41 at a predetermined timing, it becomes possible to replace the main audio of the primary program stream with the main audio of the secondary program stream.

Further, the sub video signal demultiplexed by the primary demultiplexer 37a and the sub video signal demultiplexed by the secondary demultiplexer 38a are selectively supplied by a selector 42 to a sub video decoder 40c that configures the decoder unit 40 to be subjected to decode processing. By switching the selector 42 at a predetermined timing, it becomes possible to replace the sub video of the primary program stream with the sub video of the secondary program stream.

The main video signal demultiplexed by the primary demultiplexer 37a is supplied to a main video decoder 40d that configures the decoder unit 40 to be subjected to decode processing. Further, the sub picture signal demultiplexed by the primary demultiplexer 37a is supplied to a sub picture decoder 40a that configures the decoder unit 40 to be subjected to decode processing.

Here, the above-described primary demultiplexer 37a demultiplexes a control signal from an input primary program stream, and the control signal is supplied to the STC 27 to be provided for generation of a time clock. Then, the decoders 40a to 40e that configure the decoder unit 40 execute decode processing, respectively, on the basis of a time clock output from the STC 27.

Picture-based signals output from the main video decoder 40d, sub video decoder 40c, and sub picture decoder 40e are synthesized by a video graphic engine 43a that configures a signal output unit 43 to be output.

Voice-based signals output from the main audio decoder 40b and sub audio decoder 40a are synthesized by an audio mixing engine 43b that configures the signal output unit 43 to be output.

Here, a navigation management unit 44 is connected to the data access management unit 35. The navigation management unit 44 receives from the data access management unit 35: a reproduction start time PS_S_PTM_prm that is one of time information contained in the primary program stream; a reproduction start time PS_S_PTM_scd that is one of time information contained in the secondary program stream; and a playlist, described in the optical disk 11, that is information indicating a reproduction sequence of the primary and secondary program streams.

These reproduction start times PS_S_PTM_prm and PS_S_PTM_scd are assumed to be described in PTM (presentation time) capable of specifying a time in units of video field and to be expressed in 90 kHz and 32 bits.

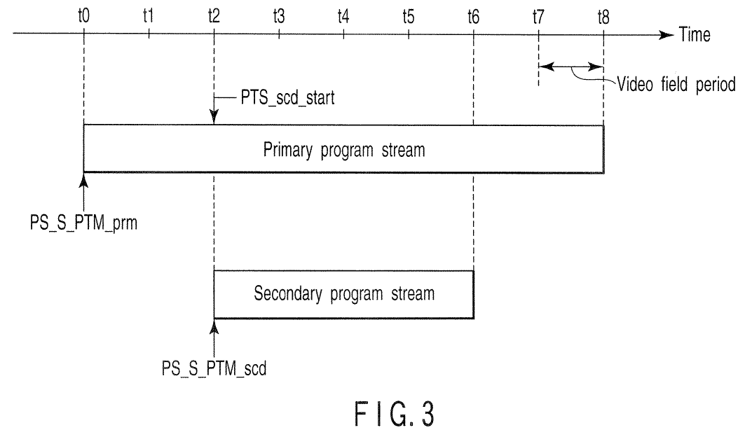

FIG. 3 shows an exemplary play list. In the play list, a reproduction start time and a reproduction end time between the primary program stream and the secondary program stream are described in units of video field periods ( 1/59.94 seconds in 525/60 system and 1/50 seconds in 625/50 system). In other words, the primary program stream is reproduced at a time ranging from t0 to t8, and the secondary program stream is reproduced at a time ranging from t2 to t6.

The above-described navigation management unit 44 calculates as follows an offset between the time bases of the primary program stream and the secondary program stream on the basis of the input playlist, the reproduction start time PS_S_PTM_prm of the primary program stream, and the reproduction start time PS_S_PTM_scd of the secondary program stream.

That is, in the case where reproduction of the primary program stream has been started at time t0, a time t2 after 2 fields thereof is obtained as a reproduction start time PTS_scd_start of the secondary program stream. Namely, it can be expressed as follows:
PTS_{—}scd_start=PS_{—}S_{—}PTM_{—}prm+(t2−t0)× field_period
wherein field_period denotes a value obtained when a video field period is expressed in units of 90 kHz.

As a consequence, an offset ΔPTM_prm_scd between the time bases of the primary program stream and the secondary program stream is obtained as a difference between: the reproduction start time PTS_scd_start of the secondary program stream, calculated from the reproduction start time PS_S_PTM_prm of the primary program stream; and the reproduction start time PS_S_PTM_scd described in the secondary program stream. Namely, it can be obtained as follows:
ΔPTM_{—}prm_{—}scd=PTS_{—}scd_start −PS_{—}S_{—}PTM_{—}scd

The above-described navigation management unit 44 supplies to the secondary reproduction management unit 38b that manages the secondary program stream, the thus calculated offset ΔPTM_prm_scd between the time bases of the two program streams. Then, the secondary reproduction management unit 38b sets a value of the input offset ΔPTM_prm_scd to the secondary demultiplexer 38a. The secondary multiplexer 38a adds the offset ΔPTM_prm_scd to all presentation time stamps (PTSs) described in the secondary program stream.

In other words, PTS_scd that is time information on the secondary program stream is changed to:
PTS_{—}scd′=PTS_{—}scd+ΔPTM_{—}prm_{—}scd.

In this manner, the reproduction start time PS_S_PTM_scd of the secondary program stream can be adjusted to the reproduction start time PTS_scd_start of the secondary program stream, calculated from the reproduction start time PS_S_PTM_prm of the primary program stream, thereby making it possible to carry out synchronous reproduction.

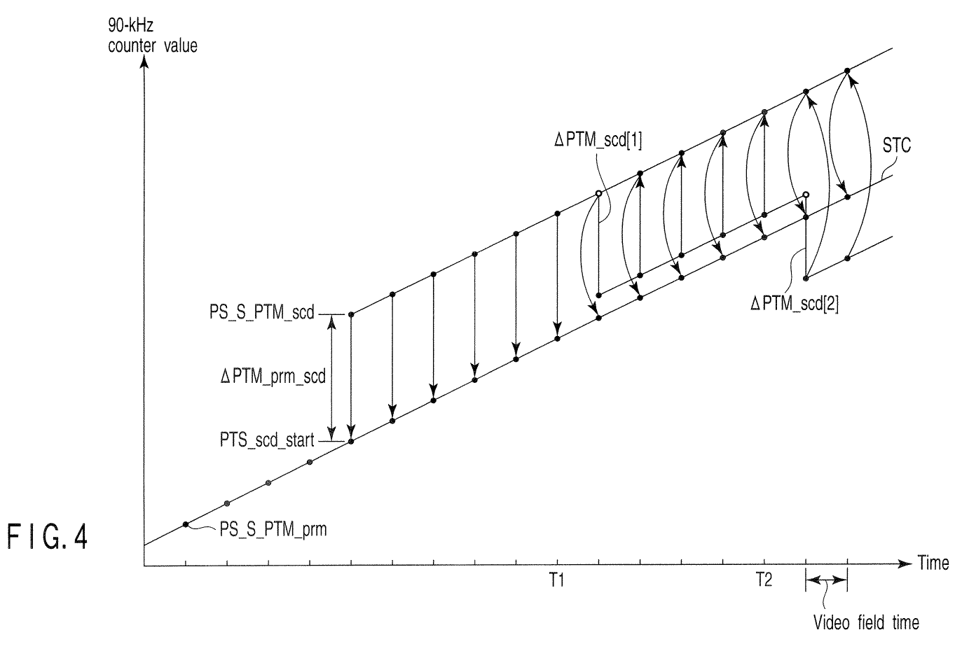

As indicated at a time T1 or earlier of FIG. 4, assume that the reproduction start time PS_S_PTM_scd of the secondary program stream has an offset ΔPTM_prm_scd with respect to the reproduction start time PS_S_PTM_prm of the primary program stream. In this case, the offset ΔPTM_prm_scd is added to all the PTSs described in the secondary program stream, whereby the reproduction start time PS_S_PTM_scd of the secondary program stream can be synchronized with the reproduction start time PS_S_PTM_prm of the primary program stream.

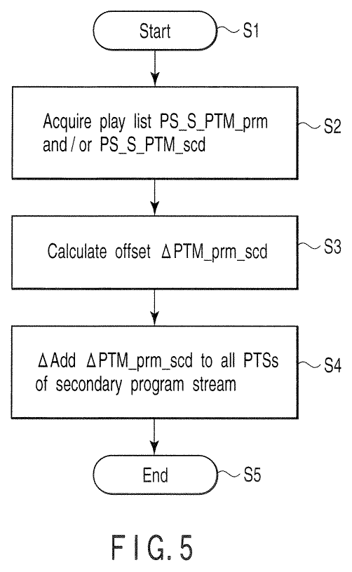

FIG. 5 is a flowchart showing the above-described operation. More specifically, at the time when processing is started (in block S1), the navigation management unit 44 receives in block S2 the play list described in an optical disk 11, the reproduction start time PS_S_PTM_prm of the primary program stream, and the reproduction start time PS_S_PTM_scd of the secondary program stream from the data access management unit 35.

Then, the navigation management unit 44 calculates in block S3 an offset ΔPTM_prm_scd between: the reproduction start time PTS_scd_start of the secondary program stream, calculated from the reproduction start time PS_S_PTM_prm of the primary program stream; and the reproduction start time PS_S_PTM_scd described in the secondary program stream.

Thereafter, the navigation management unit 44 adds in block S4 the calculated offset ΔPTM_prm_scd to all the PTSs described in the secondary program stream, and terminates processing (block S5).

According to the above-described embodiment, the offset between the time bases of the primary program stream and the secondary program stream is calculated, and the offset value is added to all the PTSs described in the secondary program stream. Consequently, it is possible to precisely synchronously reproduce two systems of program streams having different time bases with a simple configuration.

In particular, since an offset between time bases is corrected in units of PTS, it is possible to obtain synchronization in units of video fields, and to carry out precise synchronous reproduction compatible with an HD DVD standard.

Now, a description will be given with respect to a case in which a discontinuity occurs with a time stamp of the secondary program stream and seamless connection is permitted as indicated at a time on or after time T1 of FIG. 4.

First, when, as indicated at times T1 to T2 of FIG. 4, a first time stamp discontinuity occurs, an offset ΔPTM_scd[1] between the original reproduction start time PS_S_PTM_scd of the secondary program stream before such a time stamp discontinuity occurs and a reproduction start time of the secondary program stream after the time stamp discontinuity occurs can be calculated as follows:
ΔPTM_{—}scd[1]=VOBU_{—}E_{—}PTM_prev−VOBU_{—}S_{—}PTM_{—}cur
wherein VOBU_E_PTM_prev indicates a reproduction end time of a last VOBU of the preceding cells relevant to a place where a time stamp discontinuity has occurred; and VOBU_S_PMT_cur indicates a reproduction start time of a current cell when a time stamp discontinuity has occurred.

For this reason, a value obtained by adding the offset ΔPTM_scd[1] that has occurred due to an occurrence of a time stamp discontinuity to the offset ΔPTM_prm_scd of the time bases, that exists between the original primary program stream and the secondary program stream, is added to all the PTSs described in the secondary program stream.

That is, PTS_scd that is time information on the secondary program stream is changed to:
PTS_{—}scd′=PTS_{—}scd+ΔPTM_{—}scd[1]+ΔPTM_{—}prm_{—}scd.

Accordingly, it is possible to synchronously reproduce the primary program stream and the secondary program stream.

In addition, when, as indicated at times on and after time T2 of FIG. 4, a second time stamp discontinuity has occurred, an offset ΔPTM_scd[2] between a reproduction start time of the secondary program stream before the second time stamp discontinuity occurs and a reproduction start time of the secondary program stream after the second time stamp discontinuity occurs can be obtained in the same manner as that in the offset ΔPTM_scd[1] when the first time stamp discontinuity occurs.

Thus, a value obtained by adding the offsets ΔPTM_scd[1] and ΔPTM_scd[2] that have occurred due to an occurrence of two time stamp discontinuities to the offset ΔPTM_prm_scd of time bases, that exists between the primary program stream and the secondary program stream, is added to all the PTSs described in the secondary program stream.

That is, PTS_scd that is time information on the secondary program stream is changed to:
PTS_{—}scd′=PTS_{—}scd+ΔPTM_{—}scd[1] + ΔPTM_{—}prm_{—}scd[2]+ΔPTM_{—}prm_{—}scd.

Consequently, it is possible to synchronously reproduce the primary program stream and the secondary program stream.

Similarly, in the case where “i” time stamp discontinuities have occurred with the secondary program stream, a value obtained by adding a sum ΣΔPTM_scd[i] of offsets ΔPTM_scd[i] that has occurred due to an occurrence of each of the time stamp discontinuities to the offset ΔPTM_prm_scd of time bases, that exists between the primary program stream and the secondary program stream, is added to all the PTSs described in the secondary program stream.

That is, PTS_scd that is time information on the secondary program stream is changed to:
PTS_{—}scd′=PTS_{—}scd +ΣΔPTM_{—}scd[i] +ΔPTMprm_{—}scd.

Consequently, it is possible to synchronously reproduce the primary program stream and the secondary program stream.

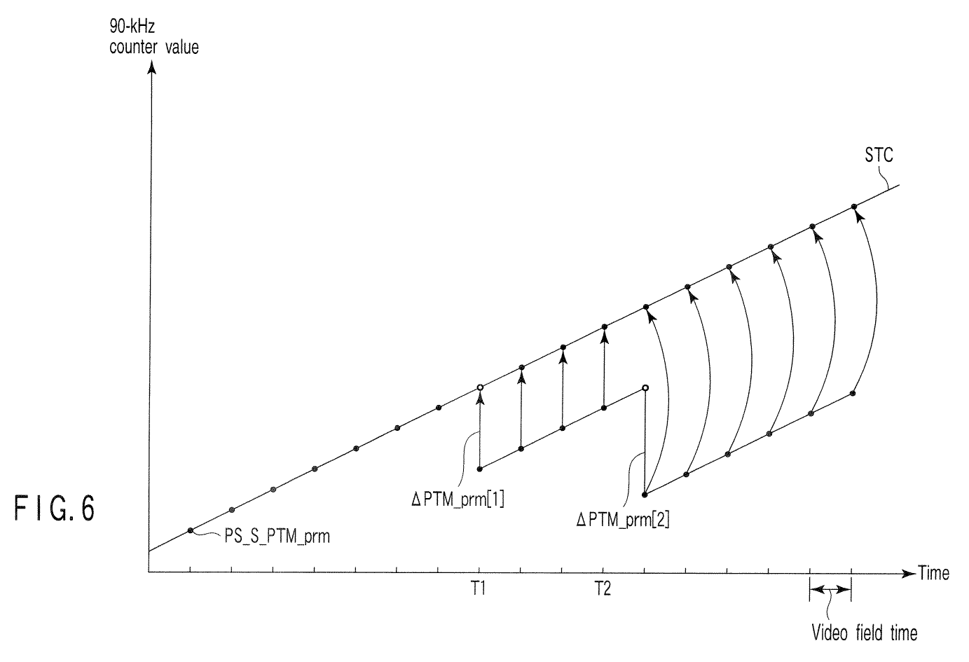

Now, a description will be given with respect to a case in which a discontinuity occurs with a time stamp of the primary program stream as shown in FIG. 6, and seamless connection is permitted.

First, when, as indicated at time ranging from T1 to T2 of FIG. 6, a first time stamp discontinuity occurs, an offset ΔPTM_prm[1] between the original reproduction start time PS_S_PTM_prm of the primary program stream before the time stamp discontinuity occurs and a reproduction start time of the primary program stream after the time stamp discontinuity occurs can be calculated as follows:
ΔPTM_{—}prm[1]=VOBU_{—}E_{—}PMT_prev −VOBU_{—}S_{—}PMT_{—}cur
wherein VOBU_E_PMT_prev indicates a reproduction end time of a last VOBY of the preceding cells relevant to a place where a time stamp discontinuity has occurred; and VOBU_S_PMT_cur indicates a reproduction start time of a current cell when a time stamp discontinuity has occurred.

Thus, the offset ΔPTM_prm[1] that has occurred because of an occurrence of a time stamp discontinuity is added to all the PTSs described in the primary program stream. That is, PTS_prm that is time information on the primary program stream is changed to:
PTS_{—}prm′=PTS_{—}prm+PTM_{—}prm[1].

Consequently, it is possible to synchronously reproduce the primary program stream and the secondary program stream.

In addition, when, as indicated in times on and after time T2 of FIG. 6, a second time stamp discontinuity has occurred, an offset ΔPTM_prm[2] between a reproduction start time of the primary program stream before the second time stamp occurs and a reproduction start time of the primary program stream after the second time stamp discontinuity occurs can be obtained in the same manner as that in the offset ΔPTM_prm[1] at the time of an occurrence of the first time stamp discontinuity.

Thus, a value obtained by adding the offsets ΔPTM_prm[1] and ΔPTM_prm[2] that have occurred due to an occurrence of two time stamp discontinuities is added to all the PTSs described in the primary program stream.

That is, PTS_prm that is time information on the primary program stream is changed to:
PTS_{—}prm′=PTS_{—}prm+ΔPTM_{—}prm[1]+ΔPTM_{—}prm[2].

Consequently, it is possible to synchronously reproduce the primary program stream and the secondary program stream.

Similarly, in the case where “i” time stamp discontinuities have occurred in the secondary program stream, a sum ΣΔPTM_prm[i] of offsets ΔPTM_prm[1] that have occurred because of an occurrence of each of the time stamp discontinuities is added to all the PTSs described in the primary program stream.

That is, PTS_prm that is time information on the primary program stream is changed to:
PTS_{—}prm′=PTS_{—}prm+ΣΔPTM_{—}prm[i].

Consequently, it is possible to synchronously reproduce the primary program stream and the secondary program stream.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and system described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
a first input unit configured so that a first digital data series including time information indicative of a reproduction start time in units of video fields is input;
a second input unit configured so that a second digital data series including time information indicative of a reproduction start time in units of video fields, the second digital data series having a time base different from that of the first digital data series, is input;
an offset calculating unit configured to calculate an offset between the time bases of the first and second digital data series on the basis of the reproduction start time included in the first digital data series input to the first input unit, the reproduction start time included in the second digital data series input to the second input unit, and information (playlist) for specifying a reproduction sequence of the first and second digital data series in units of video fields;
a computing unit configured to add the offset calculated by the offset calculating unit to the time information included in the second digital data series input to the second input unit; and
a reproducing unit configured to synchronously reproduce the first digital data series and the second digital data series in which the offset has been added to the time information by the computing unit, on the basis of information (playlist) for specifying a reproduction sequence of the first and second digital data series in units of video fields.

2. An information reproducing apparatus according to claim 1, wherein the offset calculating unit comprises:
a first calculating unit configured to calculate a reproduction start time of the second digital data series on the basis of the reproduction start time included in the first digital data series and the information (playlist) for specifying a reproduction sequence of the first and second digital data series; and
a second calculating unit configured to calculate a difference between the reproduction start time of the second digital data series, calculated by the first calculating unit, and the reproduction start time included in the second digital data series.

3. An information reproducing apparatus according to claim 1, wherein the first calculating unit is configured to calculate the reproduction start time of the second digital data series by adding a time from the reproduction start time included in the first digital data series to the reproduction start time of the second digital data series, indicated on the basis of the information (playlist) for specifying a reproduction sequence of the first and second digital data series.

4. An information reproducing apparatus according to claim 1, wherein the offset calculating unit is configured to, when a discontinuity has occurred in the time information in the second digital data series, calculate an offset of time information before and after the discontinuity occurs, and
the calculating unit is configures to add all offsets calculated by the offset calculating unit to the time information included in the second digital data series.

5. An information reproducing apparatus according to claim 1, wherein the offset calculating unit is configured to, when a plurality of discontinuities have occurred in the time information in the second digital data series, calculate a sum of offsets of time information before and after the respective discontinuities occur.

6. An information reproducing apparatus according to claim 1, further comprising:
a first calculating unit configured to, when a discontinuity has occurred in the time information in the first digital data series, calculate an offset of time information before and after the discontinuity occurs; and
a second calculating unit configured to add the offset calculated by the first calculating unit to the time information included in the first digital data series.

7. An information reproducing apparatus according to claim 1, wherein the first digital data series is a primary program stream including video and audio information, and
the second digital data series is a secondary program stream including video and audio information that are replaceable with video and audio information in the primary program stream.

8. An information reproducing method comprising:
a first block of inputting a first digital data series including time information indicative of a reproduction start time in units of video fields;
a second block of inputting a second digital data series including time information indicative of a reproduction start time in units of video fields, the second digital data series having a time base different from that of the first digital data series;
a third block of calculating an offset between the time bases of the first and second digital data series on the basis of the reproduction start time included in the first digital data series input in the first block, the reproduction start time included in the second digital data series input in the second block, and information (playlist) for specifying a reproduction sequence of the first and second digital data series in units of video fields;
a fourth block of adding the offset calculated in the third block to the time information included in the second digital data input in the second block; and
a fifth block of synchronously reproducing the first digital data series and the second digital data series in which the offset has been added to the time information in the fourth block, on the basis of the information (playlist) for specifying a reproduction sequence of the first and second digital data series in units of video fields.

9. An information reproducing method according to claim 8, wherein the third block comprises:
a first calculating block of calculating a reproduction start time of the second digital data series on the basis of the reproduction start time included in the first digital data series and the information (playlist) for specifying a reproduction sequence of the first and second digital data series; and
a second calculating block of calculating a difference between the reproduction start time of the second digital data series, calculated in the first calculating block, and the reproduction start time included in the second digital data series.

10. An information reproducing method according to claim 9, wherein the first calculating block calculates the reproduction start time of the second digital data series by adding a time from the reproduction start time included in the first digital data series to the reproduction start time of the second digital data series, indicated on the basis of the information (playlist) for specifying a reproduction sequence of the first and second digital data series.

11. An information reproducing method according to claim 8, wherein, when a discontinuity has occurred in the time information in the second digital data series, the third block calculates an offset of time information before and after the discontinuity occurs, and
the fourth block adds all offsets calculated in the third block to the time information included in the second digital data series.

12. An information reproducing method according to claim 11, wherein, when a plurality of discontinuities have occurred in the time information in the second digital data series, the third block calculates a sum of offsets of time information before and after the respective discontinuities occur.

13. An information reproducing method according to claim 8, further comprising:
a first calculating block of, when a discontinuity has occurred in time information in a digital data series, calculating an offset of time information before and after the discontinuity occurs; and
a second calculating block of adding the offset calculated in the first calculating block to the time information included in the first digital data series.
